(19) United States
(12) Patent Application Publication
(10) Pub. No.: US 2007/0292824 A1
(43) Pub. Date: Dec. 20, 2007

(54) Method of teaching gaming in a casino environment

(76) Inventor: James Ueltschi, Vero Beach, FL (US)

Correspondence Address: WARD & OLIVO, SUITE 300, 382 SPRINGFIELD AVENUE, SUMMIT, NJ, 07901, US

(21) Appl. No.: 11/728,666

(22) Filed: Mar. 27, 2007

Related U.S. Application Data
(60) Provisional application No. 60/787,394, filed on Mar. 29, 2006.

(51) Int. Cl. G09B 19/22; G06F 7/00

(52) U.S. Cl. 434/128; 707/1

(57) ABSTRACT

Disclosed is a system and method for teaching gaming in a casino. The system and method is highly efficient and effective for casino customers to learn table games and betting strategies from expert consultants. The present invention further provides a training program, preferably a web-based course, to train casino employees to act as expert consultants.

### RELATED APPLICATIONS

This application claims priority to U.S. Provisional Application Ser. No. 60/787,394, which is herein incorporated by reference in its entirety.

### FIELD OF THE INVENTION

The present invention generally relates to the field of teaching gaming in a casino environment. More particularly, the present invention relates to a unique system and method of training personnel, preferably employees of the casino, to be expert gaming consultants, who, in turn, teach ab initio casino customers and potential customers one or more casino games and/or betting strategies.

### BACKGROUND OF THE INVENTION

In the last ten to twenty years, there has been a sea of change in the American public's attitude towards gaming. Casino gaming was an activity that, although legal in some locales, was not considered acceptable by many Americans. That attitude has since changed dramatically. To use the vernacular, casino gaming is now “cool.” Even with this “coolness,” the fact remains that most of the demographics that would be excellent gaming prospects today were never exposed to gaming growing up. To the contrary, while they were growing up, gaming was frowned upon. Academic and career success was frequently emphasized. The result is that these Americans are the most educated and financially prosperous generation in history. However, they often know next to nothing about casino gaming. These people became successful through study and careful preparation. They controlled their environments whether it was a classroom or the office. They leave very little to chance and pursued their interests with the same single-minded determination that brought them success in business.

Competence is valued and the prospect of being exposed to any situation where they would consider themselves less than competent is anathema. After work or on vacation, they pursue their hobbies with equal determination. They take golf, tennis, and skiing lessons. They often want private lessons with the best instructors that money can buy, because they want to be the best they can be.

Today, if you look at players around a craps table, many are elderly having learned the game in the armed services during World War II, Korea, or Vietnam. If their reactions to each roll of the dice are any indication, the younger craps players are playing with money they can ill afford to lose. Entertainment does not appear to be their motivation to play. It is no wonder that table game revenues are generally flat to down in many casinos according to records filed with the New Jersey Casino Control Commission and the Nevada Gaming Commission.

Moreover, a casino floor is intimidating to some people, probably to many people. Even those players with good knowledge of one game may not know, or may not feel comfortable enough, to play other games that look intriguing to them. Casino dealers generally are very willing to explain games to players, but that is not their primary responsibility. They also typically have no training in giving instruction so they are left politely saying, “the book says . . . ” and most of the time with no feeling or interest in the player. If the dealer slows down the pace of play to explain the game to a novice, it slows down the entire table with adverse effects on wagering and possible customer dissatisfaction. If a player does develop a relationship with a dealer, that relationship is interrupted about every 45 minutes as dealers are rotated. At such times, the player may decide to stay, move on to another table, or worse, to stop gaming. Each decision will be influenced by the likelihood of establishing a new dealer relationship.

Psychologically, a player is much more likely to play or continue gaming if he feels comfortable in his surroundings. That comfort is derived from the confidence that he is playing the game properly and, more importantly, that the game is not playing him. There is a large psychological difference between playing well and losing and playing badly and losing. The financial results of losing are usually painful enough. But, if the player also plays incorrectly which decreases his odds of winning, the player may become self-deprecating and less willing to continue playing. Further, the player may logically conclude that the casino is the beneficiary of the player's poor play and that fact may adversely affect the casino/guest relationship going forward.

There is a perception that before one can play a casino game, a thorough understanding of its theory and mathematical probabilities must be achieved. That is, casino games do not appear to be a place for amateurs. The sense that table games are complicated, and therefore, difficult to understand, is heightened in the many people who consider themselves mathematically challenged. Moreover, many such potential players fear that they may interfere with the flow of the game and be seen as slowing the table action. Many first time players also fear that their uneducated bets could hurt other players' chances and could subject them to ridicule from other players. Such people will go to great lengths to avoid being judged incompetent, including, for example, entirely abstaining from playing the game.

There are many people who have expressed no desire to play casino table games or worse, have an open and vocal distain for gaming. This is particularly true of spouses, significant others, etc. of gaming fans. While the gaming fan plays, the other person frequently finds alternative ways to spend his or her time (e.g., shopping, reading by the pool). It may be that these potential gamblers would enjoy playing if provided with a non-threatening environment that would encourage them while emphasizing the fun and excitement of the casino floor. Furthermore, through personal experience that everyone can relate to, the dynamics of close personal relationships have many times demonstrated that third parties are better at teaching significant others, etc. It would be beneficial for a gaming fan to know that a spouse, family member, significant other, or business associate was being exposed to gaming in the most positive light. In turn, inter alia, the gaming fan is more likely to continue frequenting the casino, which will likely result in several advantages for the casino, including, for example, increased gaming revenue.

The winning and losing paradigm also influences gaming participation. Everyone wants to win and no one wants to lose. However, it is a mathematical certainty that more people will lose than win at gaming. Aside from the obvious financial consequences, there are psychological factors that are also very important. If a player can be influenced to focus on the thrill of the game's action as the primary entertainment objective (rather than the financial outcome), and provided that betting is done responsibly, then if/when the customer loses he will not identify himself as a “loser,” but rather as someone who was well entertained albeit at some cost and who “may do better next time.” The casino cannot teach this insight because, in the eyes of the player, his loss is the casino's gain. Accordingly, there is a real conflict of interest. As a player retreats from the table after losing, the dealer's parting words of “good luck” often leave a bitter taste in everyone who has ever heard them.

Some schools have attempted to teach gaming outside of the casino, such as in a classroom setting. Many customers, however, find classroom settings uninteresting and not the way they would like to spend a vacation.

Others have alleged to provide instruction to students within casinos, however, these people have done so without the authorization of the casino. While casinos sometimes reluctantly tolerate such arrangements because such individuals have ingratiated themselves with their customers, casinos are also weary of allowing unlicensed and untrained third parties to potentially take advantage of their customers.

Although casinos maintain extensive databases on their past and current players and invest large amounts of money on player development activities, virtually all the effort is concentrated on a retrospective view of players' wagering histories, such databases are typically developed by issuing players “comp” cards. When a player sits at a table the casino management will obtain the player's information from the player's card. The player's identification information is collected either manually or more recently by computer swipe and entered into a database controlled by a computer system. The player's level of wagering activity is tracked by the casino. Typically, the casino management will watch the player and manually enter a “level of play” into the computer system. Alternately, the level of play may be calculated by the system based on the time and table limit(s) for the various table(s) player sits at.

There is no doubt that looking into the past has merit. However, there exists a need for developing and influencing potential high volume prospects who have little or no wagering histories. Moreover, there exists a need for a method of leveraging this database system to acquire new prospects.

In view of the foregoing, a need clearly exists for a method for introducing certain people to casino gaming techniques in a manner that will be exciting and secure. The system and method trains personnel to be expert consultants, who, in turn, teach casino customers one or more casino games and/or betting strategies.

### SUMMARY OF THE INVENTION

The present invention generally discloses a system and method for training personnel to be expert consultants, who, in turn, teach casino customers one or more casino games and/or betting strategies.

In accordance with one aspect of the invention, a casino will enter into a long-term contract with a training organization that will make available to the casino's customers an expert consultant (e.g., a half day with a two hour minimum) to teach one or more table games and betting strategies, preferably including the racetrack and sport book. The training is preferably individualized and client driven and, most preferably no more than two customers will work with each consultant. In an alternate embodiment, groups, preferably of twenty or less customers will be taught at one time as a group by one or more expert consultants.

Learning is an active process, and the lecture method tends to foster passiveness and instructor dependence. This fact is confirmed by numerous studies that confirm the fact that individuals given lectures have roughly a 5% retention rate over a 24-hour period, but those actively engaged in the learning process have a much higher retention. A livid, dramatic, or exciting learning experience teaches more than a routine or boring experience and learning is best achieved when individuals participate actively in a friendly, relaxed atmosphere. This increases the level of fun and customer satisfaction.

Accordingly, instead of classroom lectures, the preferred embodiment of the present invention utilizes an interactive learning environment whereby the customers learn by watching and playing at live tables. Alternatively, where and when appropriate, customers may be taught utilizing a combination of classroom lectures and watching and playing at live tables. Furthermore, in addition to instruction at live tables, the system and method of the present invention may, when and where appropriate, utilize learning tables (i.e., tables designed for the sole purpose of teaching customers a particular game and/or strategy), but only as an adjunct to instruction provided on live tables.

Consultants are preferably screened for their knowledge of the games, personality, attitude, demeanor, and foreign language skills and asked to conform to certain standards of conduct and decorum. Consultants preferably do not wear uniforms and are not otherwise identifiable except to the casino through prior knowledge. They preferably will not touch the customer's chips or money at any time unless specifically instructed, and the customer will make all wagering decisions.

The consultants are preferably off-duty employees of the casino or other casinos in the area. Because of certain contractual or legal requirements of certain jurisdictions, such employees may not be permitted to work on the casino floor of a specific establishment without the agreement of the casino, the employee's employer casino, or a relevant casino control commission.

The casino will preferably be given the right under the contract to object to any consultant unless agreeable to the casino management. In one embodiment, Poker would not be offered as there are already a number of instructional books, videos, and broadcast media saturation. More importantly, Poker is a competition between the players, not between the casino and players, so player instruction is typically not permitted.

In a preferred embodiment, the revenue for the training organization will come from customer training fees with the casino making no payment to the training organization for guest services. The training organization is preferably given some office space and a meeting area in the casino where customers can be greeted and interviewed about the service and scheduling. It is preferred that the office space is co-located within or along side the Concierge office or casino floor. Costs associated with promotion and marketing of the training organization such as video clips, printing, and other marketing, all of which are preferably subject to approval by the casino and hotel, are preferably borne by the training organization. It is also preferred that virtually all marketing will be done in conjunction with the casino and hotel so as to present to the customers a seamless product. Alternatively, should the casino prefer, the training organization may minimize its corporate identification.

Because gaming is highly regulated, the business model must be in compliance with both relevant gaming laws and regulations. Upon the signing of a contract and subject to any regulatory or compliance requirements, the training organization will need some time (e.g., X days) to commence limited service. The selection of suitable personnel and the associated training will demand a very slow and careful rollout. The organization preferably will not place personnel in service until they satisfy certain criteria and the organization is convinced that they will perform to a certain level. In the preferred embodiment, there are two determinants of the ultimate size of the organization. One is locating suitable personnel. The other is market demand. It is expected that there may be more demand than may be fulfilled at certain times.

All personnel preferably undergo a web-based proprietary training program. In the preferred embodiment of the present invention, this training program is self paced and includes a test to certify satisfactory completion. For example, before becoming certified, a prospective expert consultant may be required to complete a certain number of course hours covering a variety of vital topics after which he will take a test to confirm his comprehension of the topics. Alternatively, the present invention may utilize formal standardized classroom training with simulations over a number of days. In a further alternative embodiment, the training may include a combination of online and classroom based training.

Regardless of whether the training is online or in a classroom, the training preferably includes extensive presentations on adult learning theory and the fundamentals of instruction so that all personnel who successfully complete the training program will be well-versed in the same proven methods of behavioral and cognitive theories of learning which have been used to train pilots and technicians in aviation. Training may also include effective communication skills including conflict resolution. Communication skills must be developed; they do not occur automatically. The ability to communicate comes from experience. Therefore, a critical part of the instructor training involves role-playing scenarios that are evaluated and critiqued.

Because customers may have little or no casino experience, instructors must recognize that this lack of a common core of experience will likely create the greatest barrier to effective communication. Other critical areas to be covered during the initial training, as well as during periodic recurrent training, preferably include the necessity for professionalism at all times and the absolute adherence to the Code of Ethics as described by the American Gaming Association's Code of Conduct for Responsible Gaming. Training will necessarily require the cooperation of the casino in a number of specific areas.

The preferred embodiment of the present invention includes ongoing auditing of personnel, which is critical to success. This may include, for example, close observation by staff, feedback from the casino staff at all levels, and customer exit interviews and follow-up. Periodic and regularly scheduled meetings between the training organization and the casino management are critical to assure open communication to deliver the highest quality services to the casino and its customers. The casino preferably will enter into a multi-year Agreement naming the training organization as the authorized training organization for the services provided.

As noted above, casinos maintain extensive databases relating to their clients' gambling histories. They also have knowledge of those hotel guests who do not engage in gaming. According to the latest Atlantic City Convention and Visitors Authority Profile Study (2004), 75% of all rooms are complimentary to gamblers (footnote #15 on chart 13, page 25). An astounding 10% of all comped occupants are NOT planning to gamble AT ALL while staying in a free casino room (Chart 14, page 26). Based upon the above, such non-playing hotel guests are a significant marketing target of the invention. Therefore, appropriate in-room advertising materials are preferably displayed as well as signage at appropriate locations throughout the casino/hotel property. For those that do gamble, casinos frequently offer perks, such as meals, rooms, and tickets to shows and sporting events. In accordance with one aspect of the invention a casino will offer lessons, given by the training organization, as a perk. Such perks will preferably be offered to slot players, but may also be offered to table players either as a way to learn a new game or for the use of one or more non-players designated by the player.

In accordance with one embodiment of the invention, the casino will use its player database to identify players who predominantly play slots. The casino will then offer training lessons, through the training organization, in table games as a perk to such players.

Alternatively, the casino may identify table players who typically do not play one or more other table games and offer lessons, through the training organization, in such other games as a perk to the player.

Therefore, it is an object of the present invention to effectively train personnel to teach certain people gaming techniques in a manner that is both secure and exciting.

Another object of the present invention is to introduce certain people to gaming techniques.

Yet another object of the present invention is to teach people gaming techniques on an individual and client driven basis.

A further object of the present invention is to develop and influence high volume prospects who have little or no wagering histories.

A still further object of the present invention is to teach gaming in a live environment which benefits both the player and casino.

Another object of the present invention is to leverage a casino and hotel's databases to acquire new prospects.

A different object of the present invention is to comply with the relevant gaming laws and regulations.

Still a different object of the present invention is to enter into an agreement with a casino to authorize training services.

Further, an object of the present invention is to provide benefits to casinos for utilizing the training services.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 depicts a system whereby a casino may collect data on the gaming activity of a gaming player and of a gaming trainer according an embodiment of the present invention.

FIG. 2 depicts a flow diagram showing a process of generating increased casino revenue according to an embodiment of the present invention.

FIG. 3 depicts a flow diagram showing a process for certifying potential expert consultants according to an embodiment of the present invention.

FIG. 4 depicts a flow diagram showing a process for training and testing potential expert consultants according to an aspect of the process of FIG. 3.

FIG. 5 depicts a flow diagram showing a process for training customers according to an embodiment of the present invention.

### DETAILED DESCRIPTION OF THE DRAWINGS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment of the present invention.

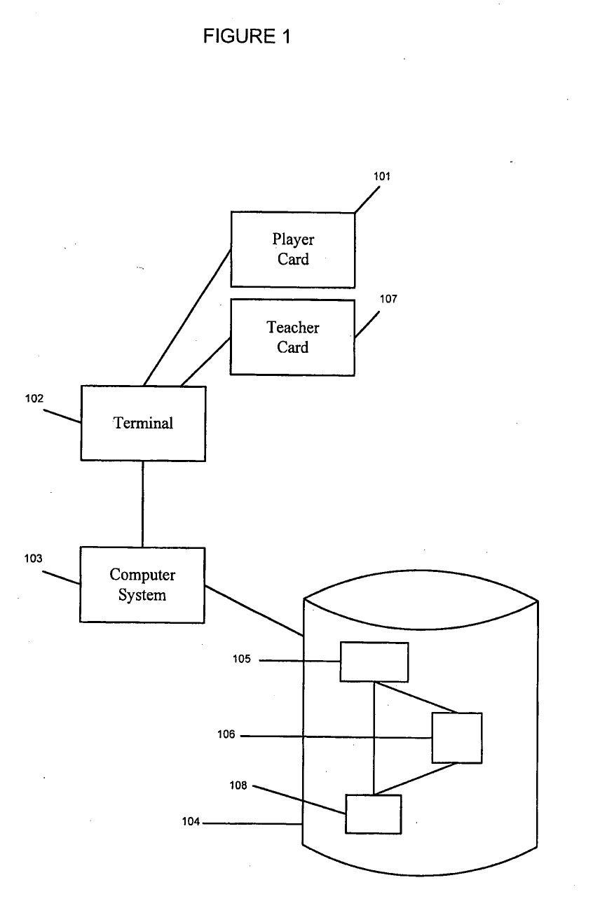

Referring first to FIG. 1, depicted is a system whereby a casino may reward the training organization for a student's level of play according an embodiment of the present invention. As shown in FIG. 1, when playing at a casino, casino personnel will record the information from the player's card (101) in a terminal (102) to track the player's level of play. The player information will be transmitted to computer system (103) which will be coupled to database (104). Database (104) will have an entry (105) associated with the player, which will include, among other information, the player's level of play. In accordance with one aspect of the invention, the player entry (105) will include, or be associated with, an entry (106) associated with the training organization. This association will allow the computer system to track the level of play associated with players who have been trained by the training organization represented by entry (106). This information may be used to financially compensate the training organization, and/or for internal decision making and marketing by the casino.

The instructor associated with the player may also be given a card (107) containing the instructor's information which information may be entered into terminal (102) and associated with player card (101). The instructor may be given an entry (108) in the database (104) which is then associated with the player entry (105) and training organization entry (106). This may also be used to compensate the instructor and/or for decision making by the training organization.

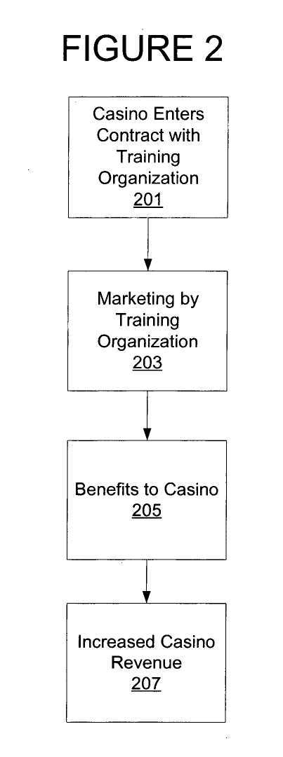

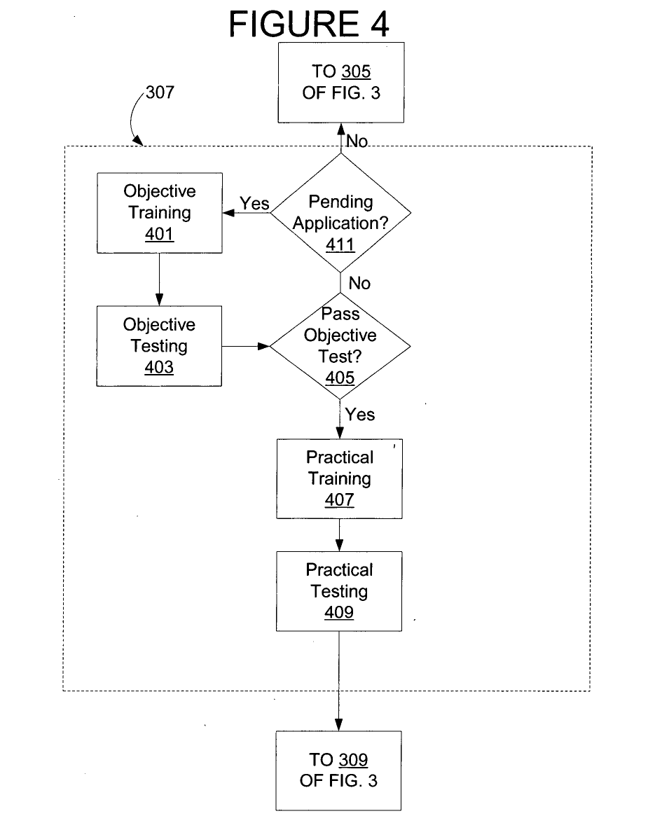

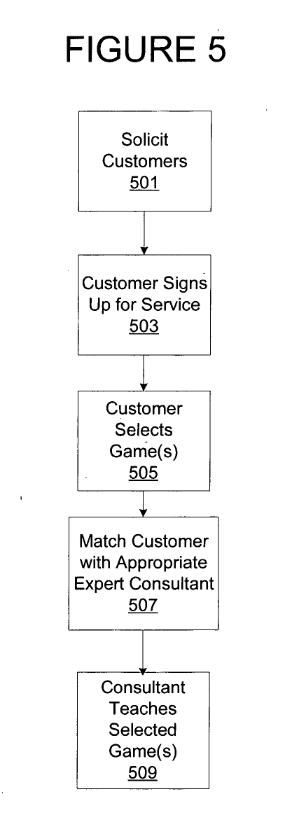

Initially, a casino preferably enters into a long-term contract/agreement with a training organization (step 201 of FIG. 2) that will make available to the casino's customers an expert consultant (trained in accordance with the process depicted in FIG. 4) to teach one or more table games and betting strategies (preferably taught according to the process shown in FIG. 5), preferably including the racetrack and sport book. Terms which may be beneficial to both the casino and training organization may include that the casino will preferably utilized services provided by the training organization to satisfy all of the casino's customer gaming training needs so long as such services meet the agreement's service and quality levels and satisfy the casino's business needs. The casino will also preferably agree that it shall not perform, authorize, permit, allow, or contract with any other person to perform any such service as specified in the agreement. In the event the training organization fails due to causes within its control to provide the training services as specified, the casino may be entitled to give written notice to the training organization that it has failed to perform its obligations. Preferably, the training organization will have an appropriate to cure any such default. After any failure to cure within the period specified, the casino, at its sole discretion, preferably could have the right to terminate the agreement in its entirety, or partially.

Once the casino enters into the agreement with the training organization (step 201), the training organization will preferably engage in a marketing campaign (step 203). Advantageously, the services provided by the training organization will preferably supplement and enhance the marketing and player development already underway. The training organization will preferably be a casino's partner, not a competitor. Moreover, the casino will preferably not have to investment in money, time, material or labor. Rather, the training organization preferably makes the investment

By utilizing the training organization, the casino will reap many benefits (step 205). For example, according to the Las Vegas Visitor Profile Annual Report for 2004 commissioned by the Las Vegas Convention and Visitors Authority, 80% of visitors decide on where they will play after they arrive. Thus, offering the training organization will likely give the casino a persuasive tool to attract these players to your property. Further, by teaming with the training organization, the casino's customers will be entertained at your casino. Preferably, guests would not be taken off premises to wager in any other casino.

Moreover, additional players will mean more revenue and corresponding profit over time. A casino's decision to team with the training organization will also likely further its reputation as an innovator and leader in the gaming industry. The training organization will also enhance a casino's reputation that it makes every effort to meet its customers' needs. By teaming with the training organization, the casino can proudly boast to its guests and its casino industry competitors that it encourages and supports efforts to improve gaming knowledge by the public. The players utilizing the training organization service will know that the house advantage was not enhanced by poor play. Players will also be more vested in their training and playing and thus likely play longer because of the interaction with the trainer and because they use their own money in the gaming training process. Along with more table play, another equally important objective of the training organization is to increase customer loyalty and goodwill to the casino that can be expected to generate more patronage to both the hotel and the casino. Lastly, by contracting with the training organization, the casino can focus on other critical aspects of the business without having to hire additional employees with the associated costs, including various company benefits or overtime

As per the agreement with the casino (step 201), the training organization provides expert consultants to the casino's customers. The training organization preferably will hire employees of the casino only. By doing so, the casino will enhance retention of its highest quality employees because participation in the organization will require continued employment with the casino. With the money and prestige-of their employment with the training organization, the casino's employees will have a tangible financial reason to stay in the employment of the casino.

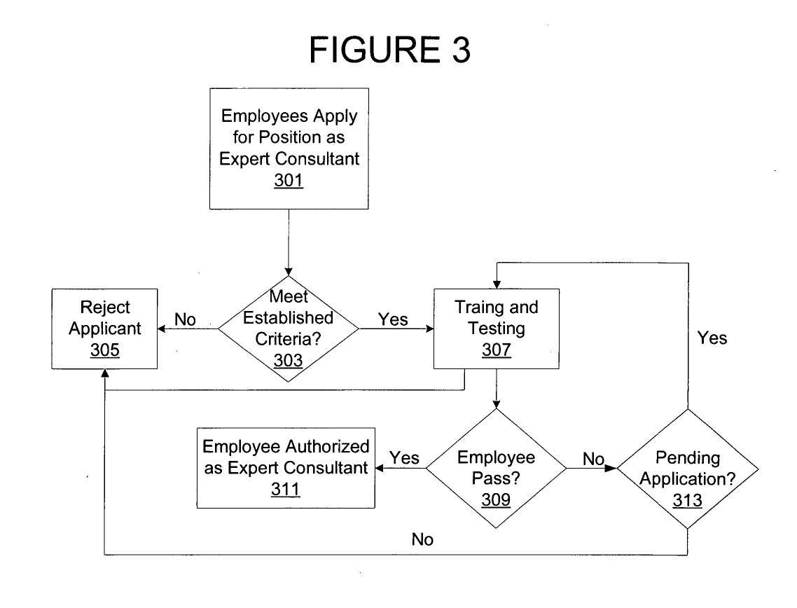

Initially, as shown in FIG. 3, casino employees are solicited to and apply for positions as an expert consultant (step 301). Although the expert consultants are preferably off-duty casino employees, because of certain contractual or legal requirements of certain jurisdictions, certain employees may not be permitted to work on the casino floor of a specific establishment without the agreement of the casino, the employee's employer casino, or a relevant casino control commission. Accordingly, the training organization will work with the necessary parties to ensure that the expert consultant is authorized to work on the specific casino floor. Furthermore, the casino could preferably be given the right to object.

One of skill in the art will readily appreciate that the expert consultants are not limited to casino employees and may include anyone who meets the requisite criteria as set forth by the training organization and/or casino. Preferably a candidate will be referred by or recommended by the casino or other trusted source. Upon receiving an application from an applicant, the training organization preferably screens the applicant according to certain, established criteria (step 303). For example, applicants may be screened for their knowledge of a certain game or games, personality, attitude, demeanor, previous experience, foreign language skills, etc. Alternatively, the applicant may be screened using a written or online process whereby the applicant fills out a questionnaire to gauge the applicant's qualifications.

The training organization preferably carefully selects suitable personnel. If the training organization determines that the prospective consultant does not meet its criteria, the organization will reject the applicant (step 305). However, if the training organization determines that the applicant meets the initial criteria to continue the process of becoming an expert consultant, the applicant will begin a training and testing process (step 307). At any time, the training organization may determine that the applicant is not suited and decide to terminate the applicant (step 305).

The training organization will train and test the applicant. As shown in FIG. 4, the training and testing process (step 307 of FIG. 3) preferably consists of (1) objective training and a written test and (2) practical training and a practical exam. The objective training (step 401) is preferably done online, although one of skill in the art will appreciate that the training may also be done in person on an individualized basis or in a classroom setting. The objective training preferably consists of a certain number of course hours covering a variety of vital topics. For example, the training may include teaching the applicant the rules of the training organization, rules and strategies of certain game(s), expected conduct, conflict resolution, communication skills, adherence to the Code of Ethics described by the American Gaming Association's Code of Conduct for Responsible Gaming, etc. The training preferably includes extensive presentations on adult learning theory and the fundamentals of instruction so that all personnel who successfully complete the training program become well-versed in certain, proven methods of behavioral and cognitive theories.

After the applicant has completed the objective training (step 401), he will take the objective test (step 403). The objective testing is preferably administered online. However, one of skill in the art will readily appreciate that such testing may be administered in a variety of ways. Upon completion of the objective test (step 403), it is determined whether the applicant passed (step 405). If the applicant failed, depending on certain criteria set by the training organization and/or the casino (step 411), the applicant may repeat the objective training and/or testing at a later time in an attempt to become an eligible for authorization as an expert consultant (steps 401 and 403) or have his application rejected (step 305). If the applicant passed, the applicant has completed the objective training and testing and moves on to the practical training (step 407) and practical testing (step 409).

The practical training and testing preferably consists of a series of simulated training situations or scenarios designed to mimic situations that the expert consultant will face when teaching a customer in a live setting. For example, the training preferably consists of a simulated customer (who himself will be trained by the training organization) asking the applicant a series of questions and coaching the applicant how to correctly respond. The testing is preferably designed to test the applicant's ability to respond to the simulated customer's questions as well as effectively assist the customer in learning the desired game(s). The practical training and testing also can serve to “standardize” common responses and advice that a consultant would give a student. For example, a standard answer to a students request to make money gaming would be to inform the student that casing gaming is a form of entertainment and it should not be expected to be a money-making venture. Such standardization will help ensure that the expectations of the customers are controlled and met.

If the applicant passes practical training and testing (step 309 of FIG. 3), he becomes eligible to serve as an expert consultant, preferably pending final approval by the training organization and/or casino (step 311). If the applicant failed, depending on certain criteria set by the training organization and/or the casino (step 313), the applicant may repeat the objective and/or practical training and/or testing (step 307) at a later time in an attempt to become an authorized expert consultant or may have his application rejected (step 305).

The training organization preferably will not place personnel in service until they satisfy certain criteria and the organization is convinced they will perform to an acceptable level. Any number of determinants may be used to determine the ultimate size of the organization. For example, the determinants may include locating suitable personnel and market demand. Furthermore, the expert consultants preferably undergo periodic recurrent training.

The present invention also preferably includes ongoing auditing of personnel, including, for example, close observation by staff, feedback from casino staff at a variety of levels, and customer exit interviews and follow-up.

After the applicant passes the test (step 309), he becomes eligible to teach customers. The training organization preferably solicits customers in a variety of ways (step 501 of FIG. 5). For example, the casino may offer perks to certain customers to receive discounted or free lessons. It is well known that casinos maintain extensive databases on their clients' gambling histories. As part of this program, they frequently offer perks, such as meals, rooms, and tickets to shows and sporting events. In accordance with one aspect of the invention a casino will offer lessons, given by the training organization, as a perk. Such perks will preferably be offered to slot players, but may also be offered to table players either as a way to learn a new game or for the use of non-player designated by the player. The training organization and/or casino may solicit customers through a variety of other ways. For example, customers may be solicited through advertisements, including in-room materials, signage, the Internet, and word-of-mouth, etc.

Once solicited, the customer signs up for the service (step 503). This may be done online or in person (for example, at the training organization office co-located with the Concierge or the casino floor). The customer preferably fills out a questionnaire, including, for example, what game or games he is interested in (step 505), level of experience, what goals he has for the training, etc.

After the customer selects the game or games, he is paired with an appropriate expert consultant (step 507), who then teaches the customer the desired game(s) using the method established by the training organization and/or casino (step 509). The expert consultants preferably do not wear uniforms and are not otherwise identifiable except to the casino through prior knowledge. They preferably will not touch the customer's chips or money at any time unless specifically instructed, and the customer will make all wagering decisions.

While the present invention has been described with reference to the preferred embodiment and alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A method for teaching gaming in a casino, said method comprising the steps of:
establishing an on-site training organization to teach gaming;
training casino employees to provide interactive teaching of gaming; and
utilizing a live setting in said casino for said teaching.

2. The method according to claim 1, wherein said method further comprises the step of:
marketing said teaching of gaming to customers.

3. The method according to claim 1, wherein said method further comprises the step of:
screening trainers to teach said gaming.

4. The method according to claim 2, wherein said method further comprises the step of:
accessing a database of existing customer gaming history.

5. The method of claim 1, wherein said method further comprises the step of:
utilizing a live setting in said casino for said teaching of gaming.

6. A system for management and utilization of data captured from casino gaming comprising:
one or more terminals for collecting identification information and data relating to at least a first user's gaming history;
a database, said database comprising a first entry for the at least a first user's identification and gaming history, a second entry for associating the at least a first user's identification and gaming history with a training organization.
